(19) United States
(12) Patent Application Publication
(10) Pub. No.: US 2004/0223450 A1
(43) Pub. Date: Nov. 11, 2004

(54) Method and apparatus for provisioning remote digital terminals

(76) Inventors: Brad Bridges, Winter Park, FL (US); Joel Futterman, Deltona, FL (US)

Correspondence Address: Elsa Keller, Siemens Corporation, Intellectual Property Department, 170 Wood Avenue South, Iselin, NJ, 08830, US

(21) Appl. No.: 10/809,622

(22) Filed: Mar. 25, 2004

Related U.S. Application Data
(60) Provisional application No. 60/457,340, filed on Mar. 25, 2003.

(51) Int. Cl. H04L 1/00; H04Q 7/00

(52) U.S. Cl. 370/216; 370/331

(57) ABSTRACT

Providing a remote with a stand alone capability to connect calls independently. The remote normally connects through a host that provides call connectivity to a remote user. The data is downloaded from the host to the remote needed for basic connectivity. The stand alone capability is triggered upon the detection communication link failure between the remote and the host.

### PRIORITY OF INVENTION

The instant application claims priority to the U.S. Provisional Application Ser. No. 60/457,340, filed Mar. 25, 2003, entitled ‘Method and Apparatus For Provisioning Remote Digital Terminals’ the contents of which is incorporated in its entirety herein.

### BACKGROUND

The present invention relates to provisioning remote terminals and, more particularly, to providing a remote terminal that can operate in a stand alone mode.

The present invention is applicable to any telecommunications system, but will be described herein with respect to the Integrated Digital Loop Carrier (IDLC) generic requirements as specified in /E1/. The IDLC system 100 as shown in FIG. 1a consists of an Integrated Digital Terminal (IDT) 102 within the Local Digital Switch (LDS) 104, and the RDT 106. The IDT 102 is the logical resource block within the LDS 104 that is associated with a single RDT 106. It provides a common set of services for operation, management, and administration of an RDT 106. The RDT 106 is an intelligent network element that provides connectivity between customer access lines and LDS services. Common RDT functions include A/D and D/A conversions, signal detection and generation, switching concentration, test access and channel testing, and local maintenance services. The RDT also provides operations interfaces to the LDS, local management, and a supervisory system. For more information on the architecture and requirements of an IDLC system, the open and available IEI standard, which is well known in the art, is referred to.

Now with respect to FIG. 1b, the RDT and LDS interfaces shall be briefly described. As shown, the interfaces are based on DS1 rate facilities.

These DS1 rate interfaces can be actualized by DS1, DS3, or SONET physical connections. Bearer services and access connections between the RDT 106 and LDS 104 are provided at DS0 granularity across the DS1 rates.

DS0 level communication channels are also provided between the RDT and LDS. An Embedded Operations Channel (EOC) 108 is used to transmit operation messages for port provisioning, testing, and protection switching between the RDT 106 and LDS 104. The EOC is based on the Link Access Protocol D (LAPD) protocol as specified in /E2/ and CMISE/ASN.1 messages as specified in /E4/. A second communications channel, called the Timeslot Management Channel (TMC) 110, is provided to transmit call processing messages between the RDT 106 and LDS 104 to perform per call timeslot assignment functions. The TMC also uses the LAPD protocol as specified in /E2/. Call Processing messages are based on the Q.931 protocol as specified in /E31/. Again, the invention may be applied to any telecommunications system and, for that, matter any standard or protocol.

Most services and features for RDT access subscribers are provided by the LDS. These services are managed and controlled directly or indirectly through the LDS signaling interface. Examples of these services are subscriber voice services (POTS, Centrex, 911, Multi-line hunt groups, manual service), subscriber voice band services (modem signaling, caller identification, onhook transmissions), in addition to RDT test functions (Mechanized Loop Testing (MLT)). Each of these services require permanent connectivity and communications with the host LDS via the EOC or TMC communication channel.

However, it is desirable, and may become necessary in the future, to provide a subset of these existing services at the RDT when TMC or EOC communications are lost. Further, it is not a trivial undertaking to provide an RDT in a stand alone mode. To support these services and features in an isolated condition, LDS subscriber data would have to be pre-provisioned and downloaded from the LDS to the RDT. In addition, there would have to be supplemental features that can be supported by the RDT while TMC or EOC communications are still active if the LDS subscriber data was made available. The process and functions proposed by this invention that are required to support transmission of the LDS subscriber data to the RDT will be referred to as the Subscriber Data Provisioning Services (SDPS).

The situation will be better understood by considering a concrete example. Normally, a central office handles all the higher level functions of a telephone network. In other words, all of the call processing, the administration of the phone numbers, the actual connecting of one call to another call, and all of the message protocol that would go on to different elements in the network is handled by a single post unit in a central office.

The central line interfaces that go out into the access distribution network that connect to a users phone are terminated by line frames or units. Remotes should be distinguished from local termination points. In a central office there are some locally connected line frames connected to a host control unit, but there are also remote line frames or remote line units that may be 10 or 100 miles from where the host system is located that does the high level control function for the line. These remotes are connected via t1 or el, or other connection protocol. Some of these remotes employ the RDT 106 scheme described previously. Typically, when these line frames on these lines are being processed, for example, to set up simple call processing, the line is connected to the remote line frame and the user picks up the phone. In response, the remote line frame detects that the phone has gone off hook and the GR303 protocol sends a message up to the host system and indicates line A is off hook. Then, the host comes back using the GR303 protocol and indicates that it is OK to make a connection from that line to this time slot on this t1 that comes back to the host office and then the caller obtains the connection and can start dialing digits. The host system obtains the digits and determines that those digits belong to line B. And line B is in that same remote. In response, the host sends a message via GR303 signaling to that remote unit and tells the remote to make another connection to line B. The remote does that and the central office does a switching function between the time slot of line A and the time slot line B.

A problem has arisen regarding remote line frames in the context of consolidating existing TDM networks, or when migrating existing TDM networks to packet based or next generation networks. In the mid-west United States, for example, there are a lot of rural sites and locations, where many users are spread out over a wide area. Currently, the system is arranged in a number of small central offices. For example, across Colorado or Utah, there may be a 100 central offices in several different locations, each only supplying 500 or 1000 lines. Each central office is autonomous, with their own database and own routing and their own network interfaces. As part of the consolidation and migration strategy, these existing small central office sites would be replaced by next generation remote line frames. These remote units would then home in on a single larger capacity central office. All subscriber services previously handled by each of the independent central offices would now be serviced by a single large central office, with the new remote line frames providing the access termination points.

This scenario of a large number of distributed remotes introduces a new problem to the existing network. Since the remotes are not physically located with the central office, there is a higher probability that communication between the remote and central office can be disrupted (damaged/cut T1 interfaces, repeater failures, weather conditions). Once communication with the host is lost, service is disrupted for all lines connected to that remote. For this example, this would result in no local service for an entire town or rural community, in addition to the loss of 911 emergency service.

This never was an issue previously because each local office was previously independent and autonomous and able to provide complete local service, regardless if interfaces to the network were disrupted. By centralizing the network and replacing the central offices with remotes, there has been created for the first time a need for these remotes to be able to operate on their own.

### OBJECTS AND SUMMARY OF THE INVENTION

An object of the invention is to provide a remote terminal.

Another object of the invention is to provide a remote terminal that operates in a stand alone mode.

Another object of the invention is to provide the data objects for a remote terminal to operate in a stand alone mode.

Another object of the invention is to provide the protocol for a remote terminal that operates in a stand alone mode.

In one aspect of the invention, the invention determines what is required for the remote access device to operate in an isolated manner. The basic concept is to provide the data and the ability to provide services and features in an isolated mode. The invention proposes, on the one hand, to determine the basic services which are the bare minimum that the remote device requires to operate as a host. More than this, the invention determines a sub-set of services that would be the minimum quality of service QoS acceptable to a user.

In another aspect of the invention, there is provided the protocol that controls the remote including when and how the remote enters and exits stand alone mode and how to transfer the information that the remote unit needs to operate in the isolated mode.

Exactly how the remote unit uses the data to connect a phone call is well understood in the art. This invention proposes a way to make it possible for the remote unit to do that. The remote essentially performs the same connection process as the host. This invention defines what data is required and how it is transmitted to the remote unit as well as how the remote unit knows how to come in and out of stand alone mode.

The invention further proposes, on a logical level, how to modify at least one protocol to effect the stand alone mode for the remote devices. As an example, the invention proposes additions and modifications to the Q.93× protocol of the GR -303 standard. Other protocols may be similarly modified. GR 303 here is what an RDT is and how it is supposed to operate and how the host system communicates with a host system and vice versa. GR303 proscribes using communication protocol Q.921 and Q.931 to implement the concepts that the standard describes. Of course, other protocols are applicable to the present invention as well as other standards.

### BRIEF DESCRIPTION OF THE DRAWINGS

The invention shall be described in more detail with reference to the following drawings, wherein at least one example of the invention is illustrated:

FIG. 1a is a general block diagram of the system according to one embodiment of the present invention;

FIG. 1b illustrates an IDLC Signaling Structure;

FIG. 2 illustrates Subscriber Data Provisioning Services OS Data Link;

FIG. 3a illustrates a Line Data Download Flow;

FIG. 3b illustrates a SAS Mode Transition Flow;

FIG. 3c illustrates a SAS Mode Recovery to Normal Mode Flow;

FIG. 3d illustrates a Administration Change Notification (Dynamic) Flow;

FIG. 3e illustrates an Administration Change Notification (Static) Flow;

FIG. 3f illustrates a Administration Sequence Number Mismatch Detected Flow; and

FIG. 3g illustrates a Database Synchronization an Status Flow.

### DETAILED DESCRIPTION OF THE PREFERRED EMBODIMENTS

As indicated, the invention determines what is required for the remote access device to operate in an isolated manner. The basic concept is to provide the data and the ability to provide services and features in an isolated mode. The invention proposes, on the one hand, to determine the basic services which are the bare minimum that the remote device requires to operate as a host. More than this, the invention determines a sub-set of services that would be the minimum quality of service QoS acceptable to a user. It shall be appreciated that the invention is not limited to the GR 303 standard, but that the invention encompasses the broad concept of selecting the components necessary for a remote device to operate independently and the protocol to control the remote device.

The remote line frame needs to obtain the phone number and other supporting information from the central office. The remote requires a locally stored copy of that information such that when the links between that remote unit and the host system are broken or cannot communicate, then the remote unit has its own local database such that the remote can make phone calls between all of the lines that the remote controls even though the remote is not connected to the host.

The invention determines what information is necessary for the remote to function when the host communication link is broken. For basic operation, this was done by observing what data the host system needed. Basically, when the remote is in stand alone operation, the remote has to basically have the same data as the host to operate. In addition, the invention determines what information is needed for those services that comprise a sub-set of services which would be a minimum quality of service QoS acceptable to a user.

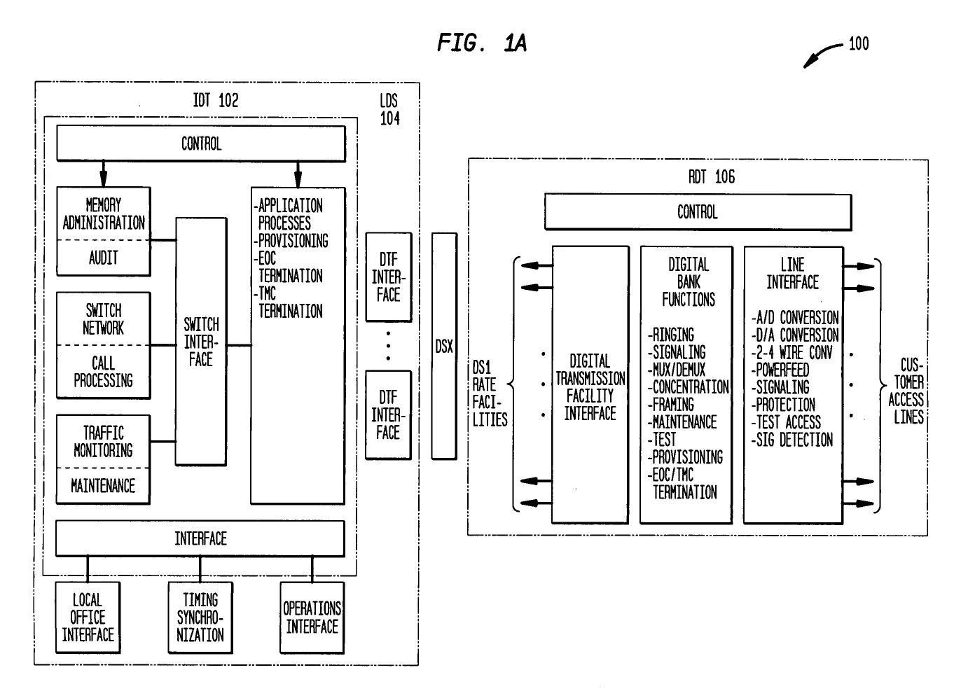

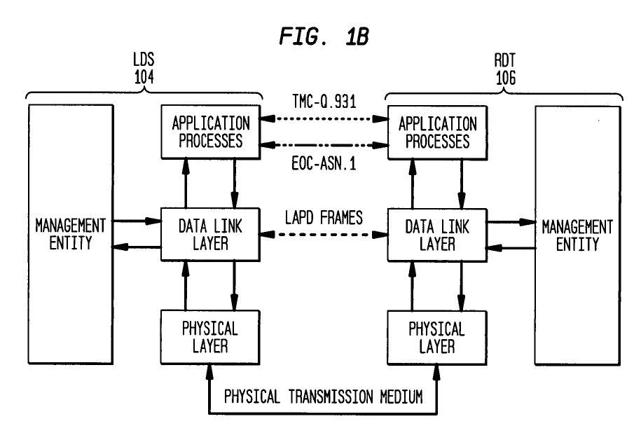

The information and services here are described particularly with regard to the RDT described in FIGS. 1a and 1b. It shall be appreciated that RDT has special requirements not existing in other environments, such as EWSD, which would have its on line frame and own proprietary remote.

Further, and as will be explained later, an RDT by definition is a standards based remote, and has its own special needs based on the GR303 standard that are different from EWSD line frames. Further it shall be appreciated that the present invention proposes a standards based approach, that is, modifying the protocol of a standard in accordance with the operating modes of the invention which has not been attempted until this time. EWSD has no standards based concept of providing the data. Again, the invention is not limited to GR303 protocols, for TDM based systems, but also covers other telecommunications environments, such as IP based and VoIP systems.

The invention determines what information is necessary for the remote to operate in a Standalone Service (SAS). That is, a capability for an RDT to provide POTs and basic call processing services for subscriber access lines under conditions when call control signaling (i.e., TMC communications) with the host LDS has been lost. SAS operation requires both subscriber DN data from the LDS as well as locally administered configuration data from the RDT management system. The data has been determined by the invention based on the following call processing functions provided by the RDT while in standalone mode.

1. POTs service for Loop Start, Ground Start, Coin Access Lines

2. B911 Service

3. Multi Line Hunt Group Service

4. Centrex (including Attendant services, public network and intercom dialing)

5. Manual Service Essential Service Protection

While only the POTS service is required for minimum connectivity, the invention also has determined the basic functions which would establish a minimum QoS that would be acceptable to a user. These basic functions are not necessary, but are what the user would want to have for what has become accepted telephone functionality.

Here now are presented the data objects, i.e., the information, that are the essential items required by the remote device to be able to operate in the stand alone mode. As explained later, these are obtained by download from the host system.

The fundamental data needed for basic POTS service and additional call features are the so-named LDS Provisioned Objects The following data objects aer related to the line DN and feature data are provisioned at the LDS and downloaded to the RDT. For each line supported by the RDT, the following data is retrieved from the LDS.

7 or 10 Digit DN

Tone/Dial Pulse Service

The following additional data has been determined to be required to support other functions considered to support a minimum QoS. These are, for example, to support business lines or hunt group lines. Without these extra features the QoS would be degraded. For example, without CENTREX data, then the user would not be able to do intercom dialing.

Essential Service Protection Feature (ESPF)

Manual Service

Centrex group ID

Centrex Intercom DN

Multi Line Hunt Group ID

Multi Line Hunt Group First Member

For Centrex Group specific data, the following data has been determined to be needed for remote connection to a Centrex termination.

Attendant Access DN

Public Access Digits

For Multi Line Hunt Group Data, the following data has been determined to be needed for remote connection to a multi line hunt group.

7 or 10 digit Pilot DN

On the remote side, the following data objects are required and provisioned locally by the RDT or the supervisory system.

1. One Digit Routing Tables

2. Three Digit Routing Tables

3. Seven Digit Routing Tables

4. Ten Digit Routing Tables

5. 911/Emergency Hunt Group Tables

6. Subscriber Database Size Configuration

Actually, RDT provisioned objects are not mandatory for the basic remote standalone operation. However, from a user service, this data may be required. For basic QoS, it has been determined that this information is for cases where there are dialing patterns that are not directly related to a specific line. For example, line A has phone number A and line B has phone number B. When the user needs to dial 911, since 911 is not a 7 or 10 digit routing number, normally the host correlates this number to an emergency service point in the network.

For remote operation, certain local lines are identified as emergency service points (for exmaple, the local police or fire station). These local lines have corresponding 7 digit numbers. However, since the fact that the remote is in standalone mode should be made transparent to the subscriber, a correlation of the dialed digits 911 needs to be made to an appropriate service point. In the isolated mode of the present invention, there is a locally identified line corresponding to abbreviated numbers. These abbreviated phone numbers point to one of the local lines that already has a 7 digit number.

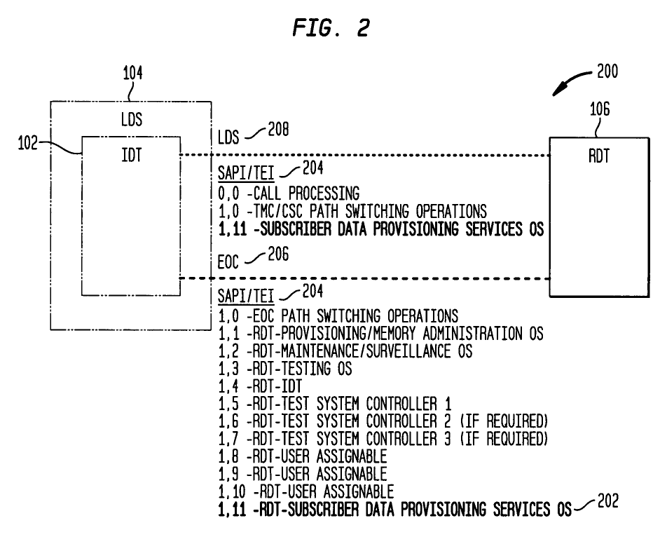

The protocol of the invention shall here be described. Here in an abstract level, the concept and mechanism to obtain the data shall be first described. The existing TMC or EOC communication channel can be used to provide the transport and interface for the Subscriber Data Provisioning Services. Since, however, both the TMC and EOC communication channels use the LAPD protocol, a new logical data link common to both interfaces is defined. FIG. 2 shows a LAPD Protocol—Data Link Layer 200 proposed by the present invention.

This new data link is identified in the figure as the RDT—Subscriber Data Provisioning Services Operations System (OS) 202. A new Service Access Point Identifier (SAPI) and Terminal Endpoint Identifier (TEI) 204 value is assigned to identify this data link. SAPI=1, TEI=11 is proposed for both EOC and TMC implementations. For EOC 206, this proposal uses one of the existing user-assignable SAPI/TEI addresses. For TMC 208, this combination is a new SAPI/TEI value to support. An extension to the GR-303 standard (see /E1/) would be required to support this. The existing procedures for logical data link initialization, recovery, and maintenance as identified in /E1/ apply to the RDT—Subscriber Data Provisioning Services logical data link. The TMC and EOC implementation and the signaling protocols to support this data link service will be discussed in more detail. In addition, it is also possible to generate a new/alternate communication channel (one or more) that is in addition to the existing TMC or EOC channels (for example, SMC—standalone mode channel). This channel would be used specifically for subscriber data provisioning and standalone mode determination. The existing provisioning and protection capabilities available for the TMC and EOC channels would be applied to the SMC channel.

Now, the mechanism to obtain the data from the host system is referred to here as Subscriber Data Provisioning Services and will be described. The Subscriber Data Provisioning Services are separated into the following three categories:

Database Download (DD) Service

Administration Change Notification (ACN) Service

Database Synchronization and Status (DSS) Service

For our example, each service is supported via the Subscriber Data Provisioning Services OS data link on the selected EOC or TMC channel described in FIG. 2. The initiator of the respective service (either RDT or IDT), will route service requests over this data link, and respond to service requests (when required) over the same data link and interface. Since the SDPS are dependent on an active TMC or EOC channel, the RDT must be in an active LDS-connected state to support these services. There is no requirement to support SDPS when the RDT is isolated from the LDS in standalone mode.

The first service offered by the present invention, Database Download Service, will now be described. Whenever the remote unit starts up, per the normal GR 303 standard, the remote units goes through some normal processing and normal sequencing in communication with the host. After the remote finishes that processing that is specified by the existing GR 303 standard, it is proposed the remote unit implement this database download service and sends a request up to the host to indicate its existence. The remote then designates its line and requests the host to send the data related to this line. In response, the host sends the requested data in a response message back down to the remote unit and the remote unit stores the message in a local database.

The remote unit cycles through this database download request asking for directory number information, special features or services that these different line have and builds the database. The database download service provides different types of data, such as normal data (normal phone number), the line type you are and if there is business or CENTREX group data, which is relevant to intercom dialing, and other data corresponding to special features associated with business related information. Further, hunt group data is downloaded to provide a user to call into a main primary number for a business and access the lines hiding behind the main number. In summary, in the first service, the remote device knows what it needs and asks the host system for it at start up time. And once it obtains all that data it stores it away.

Thus, the database download service defines the mechanism to provide the subscriber DN and Feature Data to the RDT. It is comprised of three distinct primitives:

Line Data

Centrex Group Data

Multi Line Hunt Group Data

The download process, for example, cycles through the three data primitives in sequential order. The Line Data is a mandatory primitive for basic telephone service and should be the first to be executed. The Centrex and MLHG assignments derived from the received line data, the next two segments, are optional but are required for the minimum QoS mentioned.

The Database Download Service Control Flow is described here. The database download process is a simple request/response interaction between the RDT and IDT. The RDT is the master of this process. The IDT acknowledges and provides the response data for each request. The download requests and responses may be sized to fit within a single LAPD I-Frame. This is suggested to eliminate the complexity of supporting multiple responses for a single request.

The download service begins with a request for the Line Data objects. The RDT requests the Line DN and Feature Data for a set of access lines in that RDT. A single or group of lines can be identified in one line data request by the RDT. The IDT responds with the line data assigned for each of the requested lines. The RDT continues the request process until all line data has been received for all equipped access lines. A common identifier for the individual line objects (such as the call reference value) is required for this primitive.

The RDT preferably provides a starting line reference number in the download request message. The IDT responds with the subscriber data for as many lines from that reference line that will fit into a single response message. The RDT then continues the requests with the line number following the last one received from the IDT. Lines not assigned in the IDT database are not included in the response messages.

The next two phases of the download process are to obtain the Centrex Group and MLHG objects. If a Centrex Group identifier was present in any of the received line data, the Centrex Group data download is executed. If an MLHG identifier was present in any of the received line data, then the MLHG data download is executed. The Centrex and MLHG download processes are the same in this proposal, but may be different. A single request with the respective group identifier for the Centrex or MLHG object is sent by the RDT. The LDS responds with the assigned group data for the requested ID. This process continues until all requested Centrex and/or MLHG group data is received. The RDT should use the Centrex and MLHG group identifiers received in the line data as the object ID in the request.

The criteria for Initiation of Database Download Services is defined here. In this embodiment, the Database Download Service is initiated by the RDT. But, this may be rearranged in other embodiments. It is triggered based, for example, on one or more of the following events:

1. Request from the local RDT administration or supervisory system interface

2. Initial start-up or restart of the RDT

3. Failure of one of the Database Download Primitives

4. Notification of an administration change at the LDS

5. Detection of a synchronization failure between the RDT and IDT

6. Transition of the RDT from standalone mode to normal mode

In order to throttle recurring download requests, it is suggested to apply a delay/wait period between the detection of download trigger events 3-6 and the start of the database download service. Detection of triggers 4 or 5 during the wait period should result in restarting the delay timer. Detection of download triggers 1 or 2 at anytime should result in a (re)start of the database download service.

In one variant, and to ensure a valid copy of previously downloaded Subscriber data is preserved during the download process, a backup copy of the current database should be maintained by the RDT. A primary and alternate data area should be allocated, one for active use, and one for download use. Once a download service is completed and validated, that database copy can be marked as valid and made available for use by RDT applications.

In another variant, the invention processes failures. Several interface errors can occur between the IDT and RDT during the database download process. These errors may include:

response timeout to the service request

data corruption detected in the response

the request is rejected by the LDS

For each of these conditions, a single retry of the current request primitive is issued. If the second request fails, the error condition is reported at the RDT. The current download service primitive is abandoned, and the next sequential download primitive is started. If any of the download primitives fail, a request for a new download service event is generated internally at the RDT.

The RDT uses both the subscriber DN and Centrex intercom information received from the IDT to build routing and dial plan tables for RDT based services. Routing and Dial Plan information is also configurable locally at the RDT. Any conflict between RDT based routing table entries and received subscriber DN data is reported locally at the RDT. The conflict is resolved by honoring the RDT routing data assignment. Optionally, the LDS routing assignment could be honored. Centrex group intercom code dial plans are created dynamically for each Centrex group identified, using the intercom codes assigned to the access line. MLHG member lists are created dynamically for each MLHG group identified. The ordering of members within the group are defined based on the order in which the subscriber DN data is received from the IDT. Note, this may be different than the ordering of lines in the group within the LDS database.

Centrex and MLHG group data is requested for group IDs assigned to DNs in the Subscriber data information received from the IDT. Centrex dial plan tables are updated by the RDT to reflect the received public access codes and attendant dial codes. Public Dial Plan Tables are updated based on the downloaded MLHG pilot DNs.

The second service offered by the present invention, Administration Change Notification Service, will now be described. The Administration Change Notification Service provides an interface for the IDT to notify the RDT that administration changes have been made to the Subscriber Data required by the RDT. The notification primitive provides two types of indications:

1. Dynamic update indicator

2. Static update indicator

A dynamic update notification indicates subscriber data has changed and the changed data for a particular RDT line is included in the notification primitive. A static update notification indicates subscriber data has changed and a Database Download Service request should be initiated by the RDT to obtain the modified data. The IDT determines what indicator to set based on the line data object modified. This service is initiated by the IDT only. No response is required from the RDT.

This primitive also contains an administration sequence number. This number is maintained by both the IDT and RDT. The purpose of the sequence number is to ensure that both the IDT and RDT are synchronized in regards to ongoing database changes. Whenever an IDT sends a notification, it increments the sequence number. The RDT performs the same operation on receipt of notifications. The RDT compares it's computed sequence number with that received in the notification request. If a mismatch is detected, the RDT is responsible for initiating the Database Download Service to re-synchronize the subscriber data.

The third service offered by the present invention, the Database Synchronization and Status Service provides a mechanism to ensure that administration changes to LDS subscriber data are properly reported to the RDT. It also provides an interface for the RDT to obtain any pertinent system status information regarding the IDT or LDS availability or communication status

Similar to the database download process, the Database Synchronization and Status service is also a request/response interaction between the RDT and IDT. The RDT is the master of this process. The IDT acknowledges and provides the response data.

Two functions are defined within the DSS Service primitive:

request for the administration sequence number

request for IDT/LDS system status

The administration sequence number is also examined in this service to detect any missed administration change notifications during extended periods of time between any Administration Change Notification requests. In addition, following an RDT restart or transition from standalone mode to normal mode, the local RDT administration sequence number is synchronized with the RDT administration sequence number received from the LDS via this service. This service is in one preferred embodiment a constantly recurring process where the period is either pre-defined or optionally configurable at the RDT.

The IDT/LDS system status information can be set up as user-assignable and can provide an alternate or additional mechanism to detect LDS or IDT faults.

Now having defined the Subscriber Data Provisioning services provided by the present invention, we shall now describe the manner in which the invention describers how the remote decides to go in and out of stand alone, or isolation, mode, hereafter referred to as SAS Mode Activation and Recovery. This portion shall describe this feature with particular reference to GR 303, although this is merely an example of the standard employed.

Entrance and exit to and from RDT Standalone mode is triggered by the status and availability of the TMC/TMC′ communications channel. Note, for the scope of this discussion, and this discussion alone, it is assumed the RDT supports more than one DS1 interface, and therefore, per /E1/, must support TMC Path Protection Switching.

In order to activate the Stand Alone Service, or SAS Mode, the present invention operates as follows. Upon detection of a TMC path protection switching failure, the RDT will follow the procedures noted in /E1/ to process the failures. In addition, the RDT will start a timer (either pre-determined or optionally configurable at the RDT) as a countdown to entering standalone mode. This timer will allow for a sufficient retry time of the protection switch operation. A default value of 30 seconds is suggested. If the timer expires, and the protection switch still cannot be completed, and the reason for initiating the protection switch still remains, the RDT should enter standalone mode. During standalone mode, the RDT should continue to retry the protection switch actions to bring the backup TMC channel online. In addition, it should continue to monitor for removal of the condition that caused the initial protection switch request.

During SAS mode, the RDT is now responsible for providing the call processing functions for it's access lines. No TMC signaling should be attempted for call requests detected during SAS operation. The RDT will use the dial plan routing tables generated and subscriber feature data received from the LDS while in normal mode to provide call processing services.

Now the protocol of the invention shall be described in terms of message flows. In more detail, a logical description is provided of what the services are, what are the components, what are the parameters and what is the information, on a message by message basis. Earlier it was described how the data is obtained from the host to the remote. The way its done is through Subscriber Data Provisioning Services.

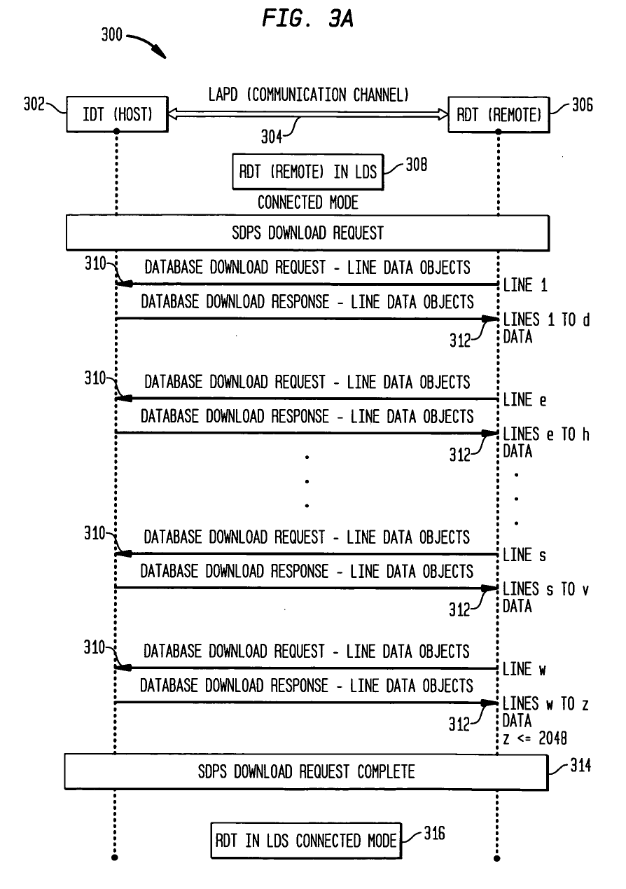

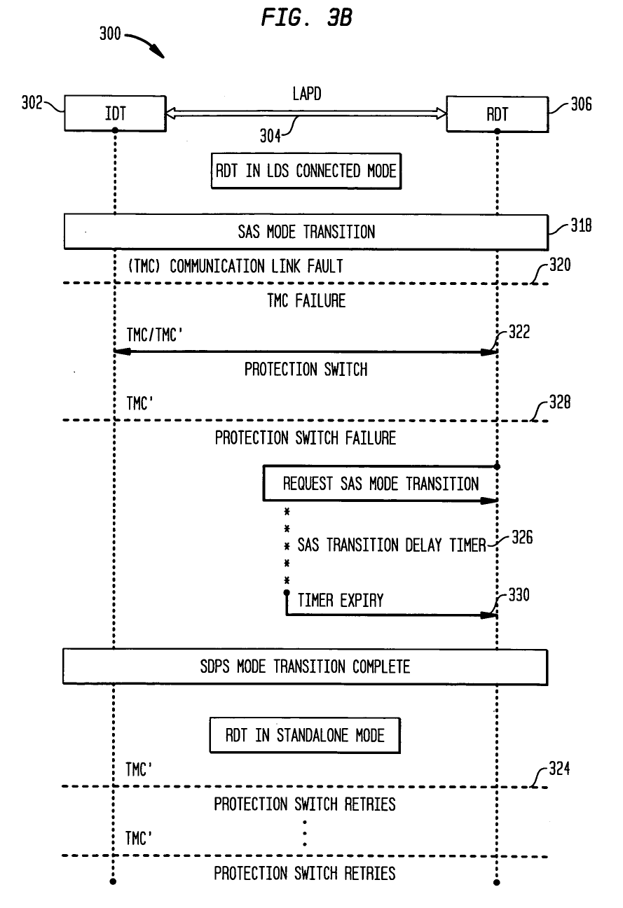

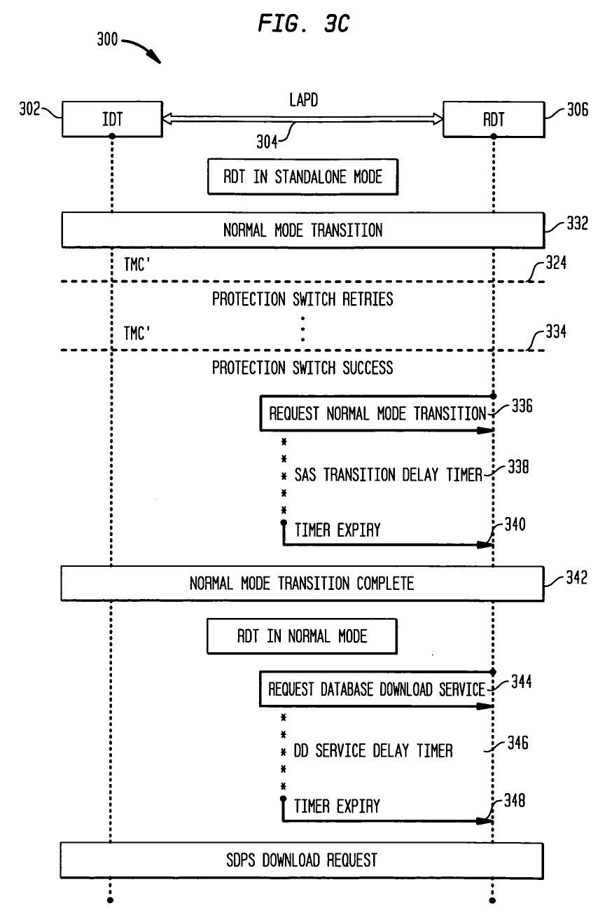

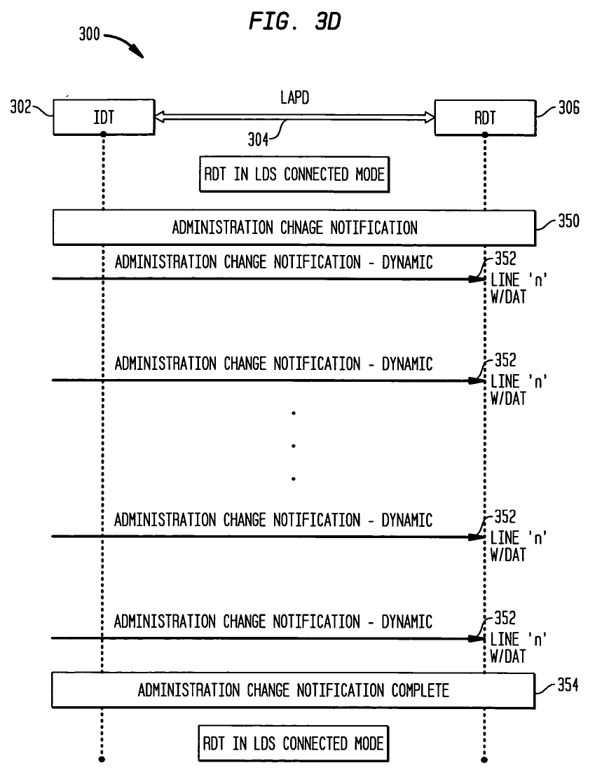

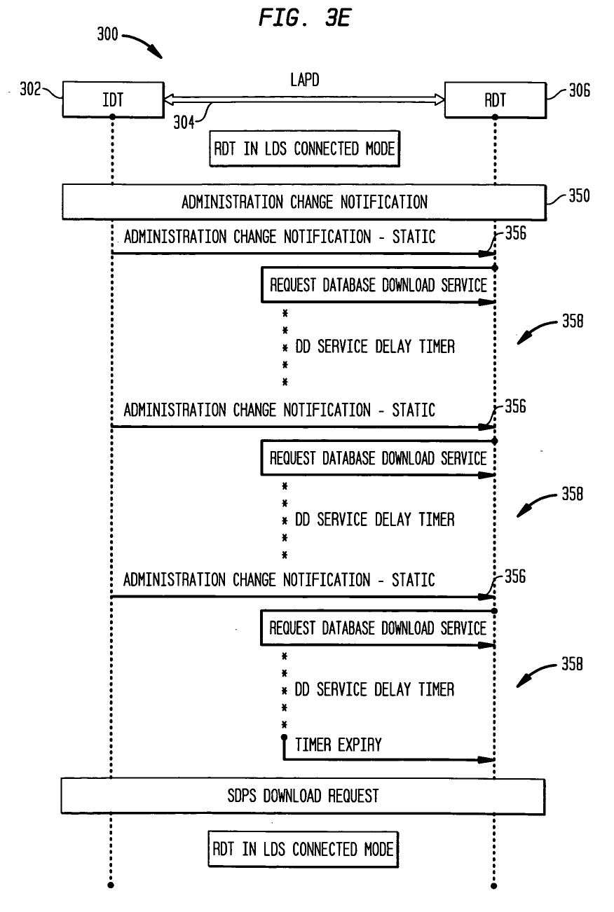

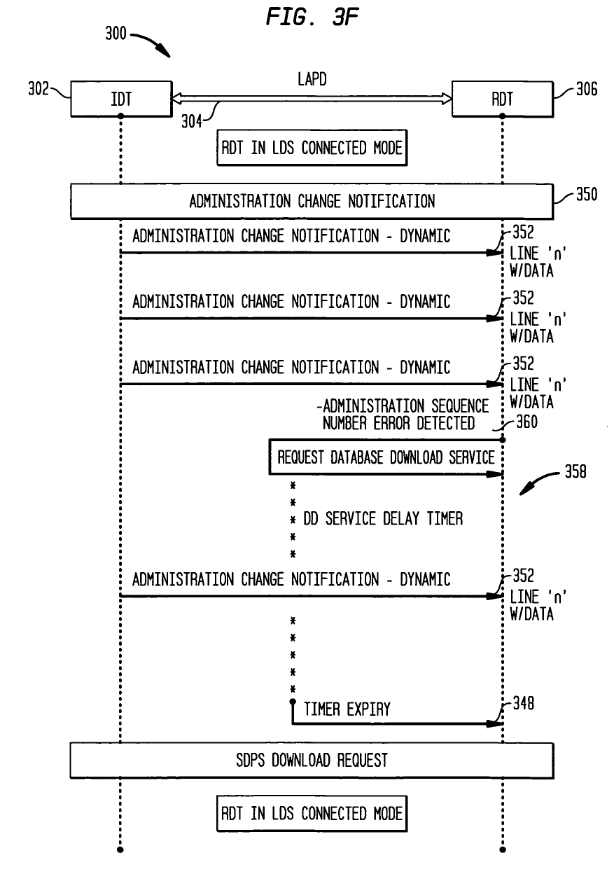

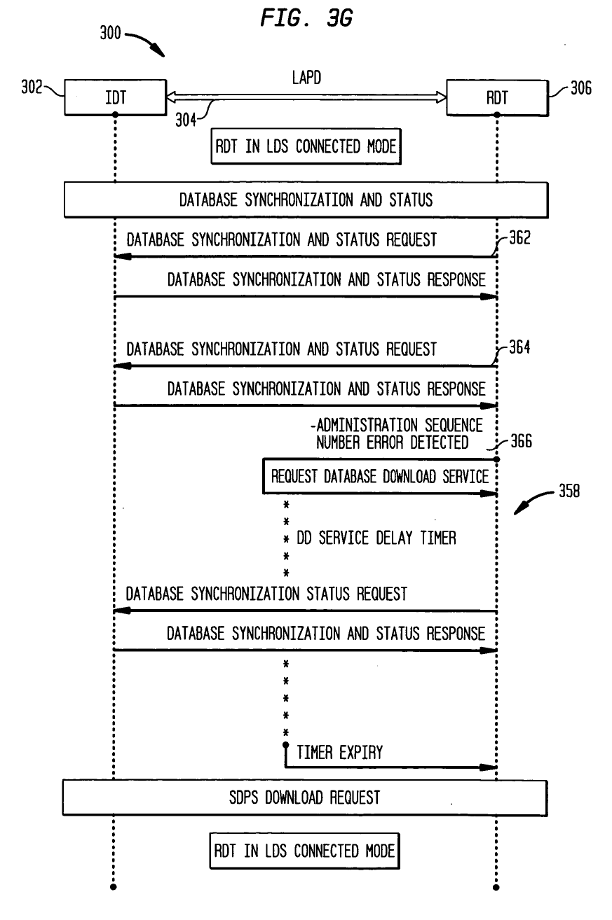

This section identifies the message components required for each SDPS service. These are broken down into the three services, database download service, administration notification service, and database synchronization and status service. Each service contains the following common components: Service, Type, Primitive, Session Identifier, Session Sequence Number. Now with respect to FIG. 3a, there is shown the message flow for a Database Download (DD) of the Service Components—that is, the components needed for the database download service. That is, here is provided the detail of what information is conveyed in the messages that support the database download service.

The message in our example can have a standardized structure, i.e, what the components of the messages are comprised of. In this example, they are the service id, type field, primitive id, session id and a sequence number. Next, for the line data objects, that are downloaded via the database download service, the Invention defines what information is provided for each of those objects.

The message flow 300 in FIG. 3a is for a database download service. As shown, there is an IDT 302 in communication through a communications link 304, such as a LAPD, with an RDT 306, which may operate in a stand alone mode 308. Here, the message flow 300 is shown in a request and a response format. The originator depends on what service it is. For example, for the database download service the remote initiates the request up to the host, and the host responds. So for Line data objects, there is a line data request 310 and the information sent in a line data request is a line id. The information sent in a line data response 312 are all the data objects previously mentioned.

Thus, the RDT 306 sends a database download request 310 and specifies a line data object and that line data object is line 1, and the database line response comes back and specifies object called line data and it sends as many lines in that response as it can fit in the message. When the request and response session is complete 314, the RDT 306 is in LDS connected mode.

For each service, there is a set of messages that are associated with it and every message has a common set of data items. These identify the value for the common fields that are in a message. FIG. 3a shows the message and comprised of a common block and a service specific block. The following data identifiers and attributes are common to each DD Service request and response.

Service=(Database Download)

Type=(Data Request|Data Response|Data Error|Data Reject)

Primitive=(Line Data|Centrex Group Data|MLHG Group Data)

Session Identifier=unique identifier for each session activated

Session Sequence Number=sequence identifier for each message in a session

The attributes that follow are specific to each DD primitive listed. For Line Data Objects, the following data is transferred.

1. Line Data Request

Line Identifier

2. Line Data Response

Line Count

Line Identifier

Feature Data Identifier=(Tone Dial, ESPF, MLHG 1^{st} member)

DN

Intercom Digits

Centrex Group Identifier

MLHG Identifier

Manual Service DN

The message flow for Centrex Group objects is similar to Data Downloads and can be superimposed on FIG. 3a. Rather than line data objects, here the invention transfers the following Centrex data.

1. Centrex Group Data Request

Centrex Group Identifier

2. Centrex Group Data Response

Centrex Group Identifier

Centrex Group Attendant DN

Centrex Group Public Access Digits

The message flow for Multi Line Hunt Group objects is similar to Data Downloads and can be superimposed on FIG. 3a. Rather than line data objects, here the invention transfers the following Multi Line Hunt Group data.

1. MLHG Data Request

MLHG Identifier

2. MLHG Data Response

MLHG Identifier

MLHG Primary Pilot DN

MLHG Alternate Pilot DN

In cases where the subscriber data received was invalid or corrupted, or was incomplete due to interruption of the download process, the transition to SAS mode should still proceed. This is important to ensure that basic 911 services are still possible based on the local 911/emergency hunt group routing data that is provisioned at the RDT. Access lines involved in active connections to DS0s on LDS DS1 facilities should be maintained when transitioning to SAS mode. The RDT should monitor these lines for release (i.e. on-hook CAS supervision) requests. Once detected, the lines should be idled. These releases are not reported to the IDT.

In such situations, the invention provides for an SAS Mode Recovery as shown in FIG. 3b. During an SAS mode transition, there may occur a communication link fault 320. In this case, the RDT 306 continues the attempt to establish the TMC protection switch 322, or monitor for removal of the primary TMC failure condition. The attempt to establish the protection switch may be retried a number of time. If either of these conditions complete or are detected, the RDT 306 should exit from SAS mode, and return to normal operation. As with the entrance to SAS mode, the RDT 306 should activate a delay timer 326 to ensure that TMC communications are stable. This timer could be the same as used for entrance to SAS mode. If a TMC protection switch request occurs and fails during this period as indicated by 328, the SAS mode should be maintained. If the timer expires 330, and TMC communications are stable, normal RDT 306 operation with the IDT 302 should be re-established.

The transition to normal mode 332 is illustrated in FIG. 3c. When the protection switch is successfully enabled 334, a request to transition to normal mode is issued 336. An SAS transition delay timer is set 338 and at the end of the expiry of the timer 340. Once the transition back to normal mode is complete, the Database Download and Database Synchronization and Status Services 344 should be started, to obtain and synchronize the latest Subscriber data information from the LDS. Again, a DD service delay timer is set up 346 and the system repeats the download request after the expiry of the timer 348.

Active calls established during SAS mode should be maintained. They should be monitored for release and cleared without notification to the IDT. Termination requests to lines connected in calls originated during SAS mode that were preserved should be rejected back to the LDS with a cause code of busy. Calls that transitioned to a permanent state while in SAS mode, or preserved calls that eventually transition to permanent state should be idled and allowed to re-originate to the host LDS. Calls still connected to DS0s on LDS DS1 facilities should be cleared.

Now it shall be discussed how the invention configures and administers its database to support the stand alone mode. No new subscriber data is required to be administered by the LDS. The LDS is responsible for supporting the Subscriber Data Provisioning Services as outlined in the previous sections. The LDS should provide administration of the following IDT configuration items on a per IDT basis:

SDPS supported indication

SDPS OS SAPI/TEI

SDPS Signaling Channel (TMC/EOC)

In order to suppress erroneous data link errors, the LDS should identify the IDT as capable of supporting the Subscriber Data Provisioning Services. This will eliminate any unnecessary Administration Notification Change requests being sent to the RDT. This optionally can be tied to the administration of the SAPI/TEI used for the Subscriber Data Provisioning Services Data Link OS.

Now the administration for the RDT shall be discussed. That is, it is described here what the remote has to configure and administer in its database locally to the support stand alone service. The RDT is responsible for provisioning basic dial plan data and database size configurations for subscriber DN services at the RDT. It is also responsible for administration of the Subscriber Data Provisioning Service Data Link OS Address and standalone service options.

The Routing tables can be manually provisioned at the RDT. One, Three, Seven, and Ten Digit DNs can be configured. These DNs can be routed to a variety of termination points: intercept treatment (tones, recorded announcements), access lines, or additional digit collection points. This allows for dialing support of digit strings not directly related to LDS defined directory numbers (i.e. prefix digits, service access codes, etc).

A special category of routing table provisioning is provided at the RDT to support B911 services. A single or group of access lines can be defined as the termination point for 911 codes. At a minimum, line interfaces must be provided. Optionally, trunk interfaces as well as E911 support can be provided.

It may be desirable to limit the amount of database (i.e. memory) available for the optional call feature data provided by the LDS (i.e. manual service, Centrex groups, MLHGs). Therefore, the RDT optionally can provide an administration function to defined the database limits available for these features. If the database area is exceeded during a Database Download Service request, the process is aborted and the failure is reported locally at the RDT.

An optional configurable parameter can be provided by the RDT to indicate whether active calls should be preserved upon entrance to and exit from SAS mode. This is provided to allow more flexibility when interfacing with different IDTs.

Now with respect to FIGS. 3d-f, the message flow for Administration Change Notification (ACN) Service Components shall be described. The Administration Change Notification Service provides an interface for the IDT 302 to notify the RDT 306 that administration changes have been made (350) to the Subscriber Data required by the RDT 306.

In FIG. 3d, dynamic update notification 352 indicates that the subscriber data has changed and the changed data for a particular RDT line is included in the notification primitive. This is done dynamically, that is on a need basis. When the notification is complete 354, the administration task ends.

A static update notification 356 indicates subscriber data has changed and a Database Download Service request should be initiated by the RDT 306 to obtain the modified data. The IDT 302 determines what indicator to set based on the line data object modified. This service is initiated by the IDT 302. No response is normally required from the RDT 306. When a change is indicated by the change notifications 356, the invention performs an interim database download 358.

The following attributes are included based on the notification indication provided.

1. Dynamic Update Indicator

Administration Sequence Number

Line Identifier

Feature Data Identifier=(Tone Dial, ESPF, MLHG 1^{st} member)

2. Static Update Indicator

Administration Sequence Number

The invention is not limited by the features here described. By expanding the subscriber feature data provided to the RDT, these additional services could be provided by the RDT:

Advanced call processing features (Custom Calling, Class)

Enhanced Routing (Operator Services, Equal Access)

Trunking

Billing

The invention also provides for mismatch detection as will be described in FIG. 3f. For this, the primitive contains an administration sequence number.

This number is maintained by both the IDT 302 and RDT 306. The purpose of the sequence number is to ensure that both the IDT 302 and RDT 306 are synchronized in regards to ongoing database changes. Whenever an IDT 302 sends a notification such as a dynamic notification 352, it increments the sequence number. The RDT 306 performs the same operation on receipt of notifications. The RDT 306 compares it's computed sequence number with that received in the notification request. If a mismatch is detected (360), the RDT 306 is responsible for initiating the Database Download Service to re-synchronize the subscriber data.

The Database Synchronization and Status Service illustrated in FIG. 3g provides a mechanism to ensure that administration changes to LDS subscriber data are properly reported to the RDT 306. It also provides an interface for the RDT 306 to obtain any pertinent system status information regarding the IDT 302 or LDS. Similar to the database download process, the Database Synchronization and Status service is also a request/response interaction between the RDT and IDT. The RDT is the master of this process. The IDT acknowledges and provides the response data.

Two functions are defined within the DSS Service primitive:

request for the administration sequence number 362

request for IDT/LDS system status 364

When an error is detected in the administration sequence number 366, the invention initiates a database download service 358. The administration sequence number is also examined in this service to detect any missed administration change notifications during extended periods of time between any Administration Change Notification requests. In addition, following an RDT restart or transition from standalone mode to normal mode, the local RDT administration sequence number is synchronized with the RDT administration sequence number received from the LDS via this service. This service is, in one preferred embodiment, a constantly recurring process where the period is either pre-defined or optionally configurable at the RDT.

The IDT/LDS system status information can be set up as user-assignable and can provide an alternate or additional mechanism to detect LDS or IDT faults. For Database Synchronization and Status (DSS) Service Components, the following data identifiers and attributes are defined for the DSS Service request and response.

Service=(Database Synchronization and Status)

Type=(Data Request|Data Response|Data Error|Data Reject)

Primitive=(Synchronization)

Session Identifier=unique identifier for each session activated ° Session Sequence Number=sequence identifier for each message in a session

Administration Sequence Number

System Status

The following data identifiers and attributes are defined for the ACN Service request.

Service=(Administration Change Notification)

Type=(Data Request|Data Error|Data Reject)

Primitive=(Notification-Dynamic|Notification-Static)

Session Identifier=unique identifier for each session activated

Session Sequence Number=sequence identifier for each message in a session

The invention also proposes to modify a protocol to effect Subscriber Data Provisioning Services. The logical description of that is disclosed here. The precise parameters may be changed in the protocol in accordance with the following. However, the user is left to determine which parameters based on the following.

The protocol that actually implements the invention may be, for example, Q.932. The Q.932 has a service field and type field and primitive field. The data values be values placed into these existing fields defined by Q.932. The session identifier and sequence number could be fields that could be in this variable section data that can exist in the message protocol.

The actual mapping is up to the user. The language is written such that there is a header field, message number field, etc. As already mentioned, the protocol is open and could be modified with new values to existing fields. The proposal is to take the existing Q.932 message protocol and add these new values, new identifiers and perhaps new fields to that protocol.

For example, 932 provides a message, which has a header, ID and a parameter (8 bits), wherein bits 0-3 are defined and 4-7 are undefined.

Implementation of the invention may add definition for bits that are currently unused. It is also possible that the invention does not require changes to the protocol.

TAs already mentioned, it shall be appreciated that the present invention proposes a standards based approach, that is, modifying the protocol of a standard in accordance with the operating modes of the invention which has not been attempted until this time. EWSD has no standards based concept of providing the data.

Different signaling protocols are proposed to support the RDT —Subscriber Data Provisioning Services OS data link, based on the TMC or EOC implementation.

For a TMC based implementation of the RDT—Subscriber Data Provisioning Services OS data link, the procedures for Non Call Associated Signaling (NCAS) as identified in /E6/ should be used. These procedures call for using the Q.932 (see /E71) and ROSE (see /E81/, /E91) protocols to provide the transport and control plane signaling for the Subscriber Data Provisioning Services.

Under this implementation, signaling sessions are established and released by the RDT for a given set of Subscriber Data Provisioning Services.

This establishment process uses the REGISTER (establish session) and RELEASE_COMPLETE (release session) messages. Once sessions are established, the ROSE procedures, encapsulated in the FACILITY message, are then used for request and transport of the Subscriber Provisioning Services between the RDT and IDT.

INVOKE components encapsulated in the FACILITY information element are used to identify requested services. Service INVOKEs initiated by the RDT require a response component from the LDS. Responses from the LDS are encapsulated as RETURN RESULT, RETURN ERROR, or REJECT components within the FACILITY information element.

Three sessions are used by the RDT and IDT for providing the Subscriber Data Provisioning Services. One session is created for each instance of a Database Download Service Activation. This session is initiated by the RDT. Unique INVOKE and RETURN_RESULT components are defined for each phase of the database download service. A second session is created for the Database Synchronization and Status Service. This session is also initiated by the RDT. A single session is initiated and maintained for the transport of the synchronization service. This service also requires a response component from the LDS. A third session is created for each instance of an Administration Change Notification Service. This session is initiated by the IDT. A FACILITY message is sent by the LDS with an INVOKE component indicating the change condition. This INVOKE is unsolicited and requires no response from the RDT.

The specific details and format of the Subscriber Data Provisioning Services within the ROSE components of the FACILITY information element will be provided in the next revision of this document.

For an EOC based implementation of the RDT—Subscriber Data Provisioning OS data link, the procedures for GR-303 provisioning using CMISE and ASN.1 encoding as defined in /E4/, /E8/, /E9/are used. The object definitions and attributes, and ASN.1 notation model for the Subscriber Data Provisioning services will be provided in the next revision of this document.

It shall be appreciated that, although the present invention has been described with respect to a specific embodiment, the invention is not so limited and covers the broad aspect of providing a remote the capability to operate in a stand alone mode and that other variations and modifications are within the scope of the invention.

Glossary and Abbreviations

A

ACN Administration Change Notification

ASN.1 Abstract Syntax Notation 1

ATM Asynchronous Transfer Mode

B

C

CAS Channel Associated Signaling

CMA Common Modular Architecture

CMISE Common Management Information Service Element

CO Central Office

CP Coordination Processor

CPE Customer Premises Equipment

CRV Call Reference Value

D

DCO Digital Central Office

DD Database Download

DLU Digital Line Unit

DN Directory Number

DP Dial Pulse

DPN DLU Port Number

DS0 Digital Signal 0

DS1 Digital Signal 1

DS3 Digital Signal 3

DSS Database Synchronization and Status

E

EOC Embedded Operations Channel

ESPF Essential Service Protection Feature

ETSI European Telecommunications Standards Institute

F

G

GP Group Processor

H

I

IDLC Integrated Digital Loop Carrier

IDT Integrated Digital Terminal

IP Internet Protocol

ISDN Integrated Switched Digital Networks

ITU International Telecommunication Union

K

L

LAN Local Area Network

LAPD Link Access Protocol D

LDS Local Digital Switch

LE Local Exchange

LUT Line Under Test

M

MF Multi-Frequency

MLHG Multi Line Hunt Group

MLT Mechanized Loop Test

N

NT Network Termination

NTT No Test Trunk

O

OAM Operation, Administration and Maintenance

OS Operations System

P

POP Point of Presence

POTS Plain Old Telephone Service

PSTN Public Switched Telephone Network

PVC Permanent Virtual Connection

Q

QoS Quality of Service

R

RAS Remote Access Server

RDT Remote Digital Terminal

RLS Remote Line Switch

ROSE Remote Operations Service Element

S

SAPI Service Access Point Identifier

SAS Standalone Service

SDP Subscriber Data Provisioning Services

SONET Synchronous Optical Network

STM Synchronous Transport Mode

T

TEI Terminal Endpoint Identifier

TMC Timeslot Management Channel

U

V

1. A method for providing a remote with a stand alone capability to connect calls independently, wherein the remote normally connects through a host that provides call connectivity to a remote user, comprising the steps of:
downloading data from the host to the remote needed for basic connectivity; and
triggering the stand alone capability upon the detection communication link failure between the remote and the host.

2. The method of claim 1, wherein the step of downloading downloads line data needed for connecting calls.

3. The method of claim 1, wherein the step of downloading downloads call services to support a minimum quality of service.

4. The method of claim 3, wherein the data is Centrex data.

5. The method of claim 3, wherein the data is multi line hunt group data.

6. The method of claim 1, further comprising the step of providing at least one service that effects the stand alone capability.

7. The method of claim 6, wherein the service is a download service.

8. The method of claim 6, wherein the service is an administration change notification service that provides that administration changes have been made to Subscriber Data required by the remote for call connectivity.

9. The method of claim 6, wherein the service is a Database Synchronization and Status Service that provides a mechanism to ensure that administration changes to subscriber data are properly reported to the remote.

10. The method of claim 1, wherein the remote is a remote digital terminal (RDT) that operates in compliance with the GR303 standard.

11. An apparatus for providing a remote with a stand alone capability to connect calls independently, wherein the remote normally connects through a host that provides call connectivity to a remote user, comprising the steps of:
a downloading service for downloading data from the host to the remote needed for basic connectivity; and
a triggering function the stand alone capability upon the detection communication link failure between the remote and the host.

12. The apparatus of claim 11, wherein the downloading service downloads line data needed for connecting calls.

13. The apparatus of claim 11, wherein the downloading service downloads call services to support a minimum quality of service.

14. The apparatus of claim 13, wherein the data is Centrex data.

15. The apparatus of claim 13, wherein the data is multi line hunt group data.

16. The apparatus of claim 11, further comprising an administration change notification service that provides that administration changes have been made to Subscriber Data required by the remote for call connectivity.

17. The apparatus of claim 11, further comprising a Database Synchronization and Status Service that provides a mechanism to ensure that administration changes to subscriber data are properly reported to the remote.

18. The apparatus of claim 11, wherein the remote is a remote digital terminal (RDT) that operates in compliance with the GR303 standard.
